(19) United States
(12) Patent Application Publication
(10) Pub. No.: US 2018/0101927 A1
(43) Pub. Date: Apr. 12, 2018

(54) SYSTEMS AND METHODS FOR DELIVERING A MESSAGE

(71) Applicant: BEIJING DIDI INFINITY TECHNOLOGY AND DEVELOPMENT CO., LTD., Beijing (CN)

(72) Inventors: Wei TAN, Beijing (CN); Ziling WANG, Beijing (CN); Yang MENG, Beijing (CN); Kun WANG, Beijing (CN); Qi SONG, Beijing (CN); Xie LI, Beijing (CN); Zhaoxue WU, Beijing (CN)

(73) Assignee: BEIJING DIDI INFINITY TECHNOLOGY AND DEVELOPMENT C O., LTD., Beijing (CN)

(21) Appl. No.: 15/838,316

(22) Filed: Dec. 11, 2017

Related U.S. Application Data
(63) Continuation of application No. PCT/CN2016/103576, filed on Oct. 27, 2016.

(30) Foreign Application Priority Data
Oct. 27, 2015 (CN) 201510708357.X
Nov. 27, 2015 (CN) 201510851853.0
Dec. 23, 2015 (CN) 201510991928.5
Apr. 7, 2016 (CN) 201610216364.2

(51) Int. Cl. G06Q 50/30; G06F 17/30; G06Q 30/02; G06Q 50/12

(52) U.S. Cl. CPC G06Q 50/30; G06F 17/30876; G06F 17/30867; G06Q 30/0239; H04L 63/08; G06Q 50/12; G06Q 30/0269; G06Q 30/0267; G06Q 30/0224

(57) ABSTRACT

A system includes a memory storing instructions and a processor in communication with the memory. When executing the instructions, the processor may be configured to establish a communication with a mobile device via a network and identify a user identity associated with a user of a service from the mobile device. The processor may be configured to obtain a user profile associated with the user identity and identify a trigger event indicating an intention of the user to initiate a service request for a service from the mobile device. The processor may also be configured to determine, based on the user profile and the trigger event, a promotion associated with the user identity and generate a message relating to the promotion to be sent to the mobile device.

### CROSS-REFERENCE TO RELATED APPLICATIONS

This application is a continuation of international Application No. PCT/CN2016/103576, filed on Oct. 27, 2016, designating the United States of America, which claims priority of Chinese Application No. 201510708357.X, filed on Oct. 27, 2015, Chinese Application No. 201510851853.0, filed on Nov. 27, 2015, Chinese Application No. 201510991928,5, filed on Dec. 23, 2015, and Chinese Application No. 201610216364.2, filed on Apr. 7, 2016. Each of the above-referenced applications is expressly incorporated herein by reference in their entireties.

### TECHNICAL FIELD

This application generally relates to management of supply of service, and in particular, management of supply of service using network-based systems and methods.

### BACKGROUND

On-demand services such as transportation services and food ordering services are becoming more and more popular. To promote its on-demand service, a company may deliver to consumers coupons in the forms of voucher, credit, or discount. Systems that are able to deliver targeted coupons according to a specific type of consumers are desired.

### SUMMARY

One aspect of the present disclosure is directed to a system including a memory storing instructions and a processor in communication with the memory. When executing the instructions, the processor may be configured to establish a communication with a mobile device via a network and identify a user identity associated with a user of a service from the mobile device. The processor may he configured to obtain a user profile associated with the user identity and identify a trigger event indicating an intention of the user to initiate a service request for a service from the mobile device. The processor may also be configured to determine, based on the user profile and the trigger event, a promotion associated with the user identity and generate a message relating to the promotion to be sent to the mobile device.

Another aspect of the present disclosure is directed to a method. The method may include establishing a communication with a mobile device via a network and identifying a user identity associated with a user of a service from the mobile device. The method may include obtaining a user profile associated with the user identity and identifying a trigger event indicating an intention of the user to initiate a service request for a service from the mobile device. The method may also include determining, based on the user profile and the trigger event, a promotion associated with the user identity and generating a message relating to the promotion to be sent to the mobile device.

Yet another aspect of the present disclosure is directed to a non-transitory computer readable medium embodying a computer program product. The computer program product includes instructions configured to cause a computing system to establish a communication with a mobile device via a network and identify a user identity associated with a user of a service from the mobile device. The instructions may be configured to cause the computing system to obtain a user profile associated with the user identity and identify a trigger event indicating an intention of the user to initiate a service request for a service from the mobile device. The instructions may also be configured to cause the computing system to determine, based on the user profile and the trigger event, a promotion associated with the user identity, and generate a message relating to the promotion to be sent to the mobile device.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates an exemplary message delivering system according to some embodiments of the present disclosure;

FIG. 2 is an exemplary diagram of the server in the system illustrated in FIG. 1 according to some embodiments of the present disclosure;

FIG. 3 is a block diagram of an exemplary network interface according to sonic embodiments of the present disclosure;

FIG. 4 is an exemplary diagram of the processor in FIG. 2 according to an embodiment of present disclosure;

FIG. 5 is a block diagram illustrating an exemplary architecture of the information receiving module according to an embodiment of present disclosure;

FIG. 6 is a block diagram illustrating an exemplary architecture of the analyzing module according to an embodiment of present disclosure;

FIG. 7 is an exemplary diagram of the promotion setting unit of the analyzing module in FIG. 6 according to an embodiment of present disclosure;

FIG. 8 is a block diagram illustrating an exemplary architecture of the information delivering module in the processor according to an embodiment of present disclosure;

FIG. 9 is a block diagram of an exemplary computing device according to some embodiments of the present disclosure;

FIG. 10 is a flowchart of an exemplary method for delivering a message according to an embodiment of present disclosure;

FIG. 11 is a flowchart of an exemplary method for determining a user profile according to an embodiment of present disclosure;

FIG. 12 is a flowchart of an exemplary method for determining the maximal value of price according to an embodiment of present disclosure;

FIG. 13 is a flowchart of an exemplary method for determining the category of the demographic feature according to an embodiment of present disclosure;

FIG. 14 is a flowchart of an exemplary method for determining a candidate city according to an embodiment of present disclosure;

FIG. 15 is a flowchart of an exemplary method for determining a residential city according to an embodiment of present disclosure;

FIG. 16 is a flowchart of an exemplary method for determining a profession according to an embodiment of present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well known methods, procedures, systems, components, and/or circuitry have been described at a relatively high level, without detail, in order to avoid unnecessarily obscuring aspects of the present disclosure.

It will be understood that the term “system,” “device,” “unit,” and/or “module” used herein are one method to distinguish different components, elements, parts, section or assembly of different level in ascending order. However, the terms may be displaced by other expression if they may achieve the same purpose.

It will be understood that when a device, unit, or module is referred to as being “on,” “connected to” or “coupled to” another device, unit, or module, it may be directly on, connected or coupled to, or communicate with the other device, unit, or module, or an intervening device, unit, or module may be present, unless the context clearly indicates otherwise. As used herein, the term “and/or” includes any and all combinations of one or more of the associated listed items.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawing(s), all of which form a part of this specification. It is to be expressly understood, however, that the drawings(s) are for the purpose of illustration and description only and are not intended to limit the scope of the present disclosure. It is understood that the drawings are not to scale.

Moreover, while the system and method in the present disclosure is described primarily in regard to determine a state of a vehicle, it should also be understood that this is only one exemplary embodiment. The system or method of the present disclosure may be applied to any other kind of on-demand service. For example, the system or method of the present disclosure may be applied to different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system that applies management and/or distribution, for example, a system for sending and/or receiving an express. The application scenarios of the system or method of the present disclosure may include a webpage, a plug-in of a browser, a client terminal, a custom system, an internal analysis system, an artificial intelligence robot, or the like, or any combination thereof.

The term “user,” “passenger,” “requester,” “service requester,” and custom in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user equipment” in the present disclosure may refer to a tool that may be used to request a service, order a service, or facilitate the providing of the service. The term “mobile terminal” in the present disclosure may refer to a tool that may be used by a driver to provide a service. In the present disclosure, “user” and “user equipment (UE)” may be used interchangeably.

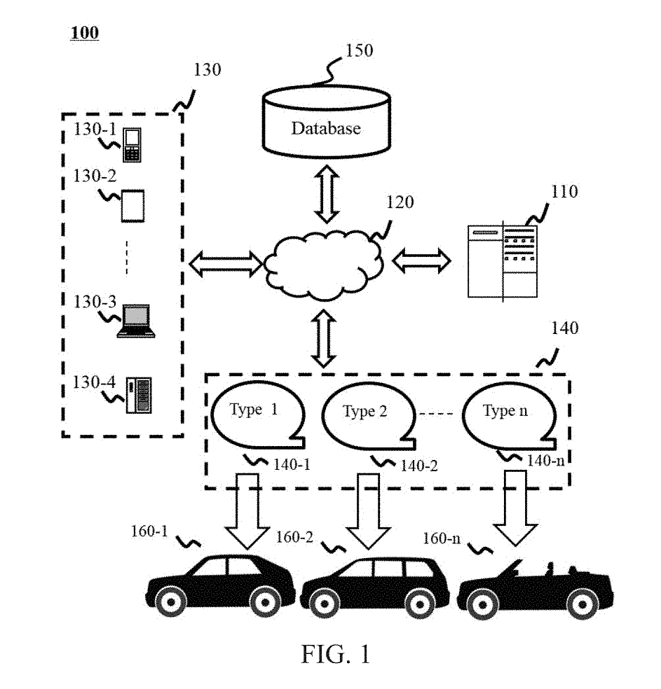

The term “service request” in the present disclosure refers to a request initiated by a user (for himself or herself, or a third party), a passenger, a requester, a service requester, a customer, or the like, or any combination thereof. The service requested may be payable upon the completion of the service or free. The term “order” in the present disclosure refers to an order sent from the server (e.g., server 110 in FIG. 1 and described below) to one or more service providers (e.g., service provider 140 in FIG. 1 and described below). The order may be generated by the server based on a service request it receives.

The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

The present disclosure describes methods and systems of a messages delivering system to determine and deliver messages about the promotion of a service. The method and system as disclosed herein aim at determining an attribute of the promotion, for example, the timing to deliver messages for the promotion or the amount of the promotion. FIG. 1 is a diagram illustrating an exemplary message delivering system 100 according to some embodiments of the present disclosure. Message delivering system 100 may include a server 110, a network 120, a mobile user equipment 130, a service provider 140, and a database 150. The message delivered to the mobile user equipment 130 may be a promotion such as a coupon, a voucher, a discount, or a credit.

Server 110 may process information and/or data relating to a user (e.g., through a user identity or user ID). For example, server 110 may establish a communication with mobile user equipment 130 via network 120. Sever 110 may also identify a user identity associated with a user of a service from mobile user equipment 130, and determine or obtain a user profession associated with the user identity. Server 110 may further identify or detect a trigger event, and determine, based on the user profile and the trigger event, a promotion associated with the user identity. Server 110 may also generate a message relating to the promotion to be sent to the mobile device. In some embodiments, the trigger event may be an indication or operation by the user at mobile user equipment 130 that is indicative of an intention of the user to initiate a service request for a service from mobile user equipment 130. For example, the trigger event may be a service request from mobile user equipment 130. Server 110 may receive and process a service request from mobile user equipment 130. Server 110 may also transmit an acknowledgement in response to the service request to mobile user equipment 130. Server 110 may further generate an order based on the service request and broadcast the generated order to one or more service providers 140. In some embodiments, server 110 may determine a promotion to be delivered to mobile user equipment 130. For example, server 110 may access historical requests of a user ID stored in database 150 through network 120 and process the historical requests. Server 110 may analyze the information, generate a promotion, and store the generated promotion. In some embodiments, the promotion may be a coupon with some benefit (e.g., a certain amount of credit). The promotion may be delivered to mobile user equipment 130 as a message when a trigger event occurs. In some embodiments, a trigger event may be a program on mobile user equipment 130 is started, the login information of a program on the mobile user equipment 130 is entered, a log-in event of the user ID, a request for the service, or a payment by the user. In some embodiments, server 110 may be a single server or a server cluster. The server cluster may be centralized or distributed. In some embodiments, server 110 may be local or remote. Server 110 may communicate with mobile user equipment 130, service provider 140, and/or database 150 via network 120. The communication may be wired or wireless. For example, server 110 may access information and/or data stored in mobile user equipment 130, service provider 140, or database 150, via network 120. As another example, server 110 may be directly connected to mobile user equipment 130, service provider 140, or database 150, and access information and/or data stored therein. In some embodiments, server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

Network 120 may be a single network or a combination of different networks. For example, network 120 may be a local area network (LAN), a wide area network (WAN), a public network, a private network, a wireless local area network (WLAN), a virtual network, a Metropolitan Area Network (MAN), a Public Telephone Switched Network (PSTN), or any combination thereof. Network 120 may also include various network access points, for example, wired or wireless access points such as base stations or Internet exchange points, through which a data source may connect to network 120 in order to transmit information via network 120. A user or requester may send a request, from mobile user equipment 130, to server 110 and receive results or suggestions via network 120. Server 110 may access information stored in database 150 or directly via network 120.

Mobile user equipment 130, which may be connected to network 120, may be a mobile device 130-1, a tablet computer 130-2, a laptop computer 130-3, a built-in device 130-4, or the like, or any combination thereof. In some embodiments, mobile device 130-1 may include a wearable device, a smart mobile device, a virtual reality device, an augmented reality device, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a HoloLens, a Gear VR, etc. In some embodiments, built-in device 130-4 may include an onboard computer, an onboard television, etc. In some embodiments, mobile user equipment 130 may be a device with positioning technology for locating the position of the user and/or the mobile user equipment 130 associated with the user. A trigger event for delivering a message may occur at mobile user equipment 130. In some embodiments, the trigger event may include an operation of a service interface, and a service interface may be a service application installed in mobile user equipment 130 or a service interface displayed in a third-party software or interact browser installed in mobile user equipment 130. In some embodiments, a service application may be a software installed in mobile user equipment 130 for user to request a service. In some embodiments, the trigger event may include a launching operation of the service application, a service request operation, or a paying operation of a service.

Services requested by mobile user equipment 130 may be of different types. For example, mobile user equipment 130 associated with a user ID may request a service of a Sport Utility Vehicle (SUV), a luxury car (LUX), a sedan, an electric car, or a taxi. The types of the services may be displayed as options on a list or tags on the mobile user equipment 130 for the user to choose or click. In some embodiments, a coupon that server 110 delivers to the mobile user equipment 130 may be used by a user for a certain type of service but not for other types of services. In some embodiments, historical requests may be categorized into groups with different types of service, and the promotion may be determined according to the historical requests of the type(s) of service. When a trigger event relating to a type of service (e.g., the user chooses a particular type of service at mobile user equipment 130) is detected, a promotion (ea., a coupon) may be determined by server 110 based on historical requests of the same type of service and delivered to the mobile user equipment 130.

Service provider 140 may be associated with a particular type of service such as one of Type 1, Type 2, . . . , and Type n (shown as 140-1, 140-2, 140-n in FIG. 1, respectively). In some embodiments, the service performed by service provider 140 may be classified based on a service type classifying strategy. For example, the service type classifying strategy may be classifying a particular service based on the type of the vehicle performing the service (e.g., a vehicle type 160-1, 160-2 or 160-n). Service type 1, type 2, . . . , and type n may correspond to vehicle type 160-1, 160-2 and 160-n, respectively. In some embodiments, the vehicle type may be a SUV, a LUX, a bus, a taxi or other types. In some embodiments, the service type classifying strategy may classify the service based on the power form of the vehicle performing the service (e.g., the vehicle is a gas-powered, diesel-powered, electrical, or hybrid car). It should be noted that the service type classifying strategy is of any form, and may be adjusted by server 110. In some embodiments, the service type classifying strategies may be stored in storage 220 or database 150 accessible to server 110. Service provider 140 may register with server 110 and submit to server 110 the information relating the service it performs. The service types may be displayed on mobile user equipment 130 available for the user to choose.

Database 150 may store registration information of users (i.e., passengers or service requesters) and service providers. Database 150 may also store historical information relating to users and service providers. The historical information may include, for example, the previous request(s) by a user or the information relating to how a service provider performed in connection with a previous service. As illustrated in FIG. 1, database 150 may be connected and accessible to server 110 through network 120. In some embodiments, mobile user equipment 130, service provider 140, and/or third party may access database 150 via the network 120. In some embodiments, there may be one gateway between database 150 and network 120, and an authentication may be needed. Thus mobile user equipment 130, service provider 140, and/or third party can access database 150 through network 120.

It should be noted that message delivering system described below is merely provided for illustrating an example of the system, and not intended to limit the scope of the present disclosure.

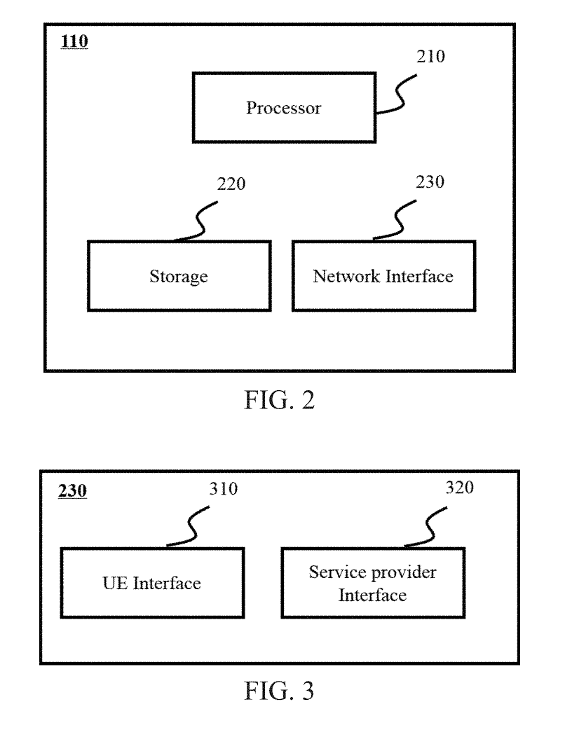

FIG. 2 is a block diagram of an exemplary server 110 in the system illustrated in FIG. 1 according to some embodiments of the present disclosure. Server 110 may include a processor 210, a storage 220, and a network interface 230. Processor 210 may process information from received from mobile user equipment 130, service provider 140, database 150, or other modules or units inside server 110. In some embodiments, the information may include a service request from mobile user equipment 130, registration information or information relating to historical requests from database 150. Processor 210 may transmit the processed information to storage 220 for storage. In some embodiments, the processed information may include promotion such as a coupon with some benefit (e.g., a certain amount of a credit or discount). In some embodiments, processor 210 may include one or more processors (e.g., single-core processor(s) or multi-core processor(s)). Merely by way of example, processor 210 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PM), a controller, a microcontroller unit, a reduced instruction-set computer (RISC), a microprocessor, or the like, or any combination thereof.

Storage 220 may store instructions for processor 210, and when executing the instructions, processor 210 may perform one or more functions described in the present disclosure. For example, storage 220 may store instructions executed by processor 210 to determine an amount of a benefit (e.g., a credit or discount) of a coupon. Storage 220 may also store data necessary for processor 210 to perform certain functions. For instance, storage 220 may store the promotion such as a coupon transmitted from processor 210, and when a trigger event occurs, the promotion may be delivered to the mobile user equipment 130 in the form of a message. As another example, storage 220 may store service request(s) from a mobile user equipment 130 (or a plurality of mobile user equipments 130), and then transmit an order(s) generated based on the service request(s) to a service provider 140 (or a plurality of service providers 140). Storage 220 may further store data for processor 210 to determine weighting factors for calculating the amount of the benefit (e.g., a credit or discount) of a coupon. For example, one or more service type classifying strategies may be used to tag a service provider 140. A service type may be a parameter for filtering historical requests used for calculating the amount of the benefit of a coupon. A service provider 140 may be classified to one of a plurality of service types according to service type classifying strategy. The service type classifying strategy may be adjusted by server 110. Other information used for determining the amount of the benefit of a coupon may be stored in storage 220.

In some embodiments, storage 220 may include a mass storage, a removable storage, a volatile read-and-write memory, a read-only memory (ROM), or the like, or any combination thereof. Exemplary mass storage may include a magnetic disk, an optical disk, a solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), or a digital versatile disk ROM.

Network interface 230 may be interface with network 120 and/or one or more components of system 100 (e.g., server 110, mobile user equipment 130, service provider 140, and database 150). In some embodiments, network interface 230 may include a mobile user equipment interface 310 (also referred to herein as “UE interface”) and a service provider interface 320. In some embodiments, network interface 230 may include other interfaces (not shown) for communicating with other components of system 100. For example, network interface 230 may include a database interface (not shown) for transmitting data to the database or receive data from database 150.

UE interface 310 may facilitate communications between server 110 and mobile user equipment 130. For example, a service request from a mobile user equipment 130 may be transmitted through UE interface 310 to server 110. As another example, server 110 may receive, from mobile user equipment 130 via UE interface 310, information relating to an operation on mobile user equipment 130 indicative of the occurrence of a trigger event (i.e., the user may initiate a service request on mobile user equipment 130). UE interface 310 may also transmit information to the mobile user equipment 130. For example, server 110 may transmit to mobile user equipment 130 via UE interface 310 a response to the service request. As another example, location information of the mobile user equipment 130 may be received by server 110 through UE interface 310 for determining candidate service providers in certain area to broadcast an order generated based on the service request to the candidate service providers. Still as another example, server 110 may deliver a message of promotion such as a coupon to the mobile user equipment 130 via UE interface 310.

The service provider interface 320 may facilitate communications between server 110 and service provider 140. For example, server 110 may transmit an order to service provider 140 through the service provider interface 320. As another example, information such as guidance, management policies or incentive policies may be transmitted from server 110 to service provider 140 via the service provider interface 320. Service provider 140 may also transmit a response to an order e.g., accepting or rejecting the order) through service provider interface 320 to server 110. As another example, location information of service provider 140 may be received by server 110 through service provider interface 320 for determining candidate service providers 140 in a certain area to broadcast the order to the candidate service providers 140.

In some embodiments, network interface 230 (e.g., UE interface 310, service provider interface 320) may be any type of wired or wireless network interface. Merely by way of example, network interface 230 (e.g., UE interface 310, service provider interface 320) may include a cable network interface, a wireline network interface, an optical fiber network interface, a telecommunications network interface, an intranet interface, an Internet interface, a local area network (LAN) interface, a wide area network (WAN) interface, a wireless local area network (WLAN) interface, a metropolitan area network (MAN) interface, a wide area network (WAN) interface, a public telephone switched network (PSTN) interface, a Bluetooth network interface, a ZigBee network interface, a near field communication (NFC) network interface, or the like, or any combination thereof.

In some embodiments, network interface 230 (e.g., UE interface 310, service provider interface 320) may be implemented according to programming and/or computer language(s). Network interface 230 (e.g., UE interface 310, mobile terminal interface 320) may include circuitry for coupling server 110 to one or more networks, and is constructed for use with one or more communication protocols and technologies including, global system for mobile communications (GSM), code-division multiple access (CDMA), time-division multiple access (TDMA), general packet radio service (GPRS), enhanced data rate for GSM evolution (EDGE), wideband code division multiple access (WCDMA), high speed downlink packet access (HSDPA), long term evolution (LTE), user datagram protocol (UDP), transmission control protocol/Internet protocol (TCP/IP), short message service (SMS), wireless application protocol (WAP), ultra-wide band (UVB), IEEE 802.16 worldwide interoperability for microwave access (WiMax), session initiated protocol/real-time transport protocol (SIP/RTP), or any of a variety of other wireless communication protocols.

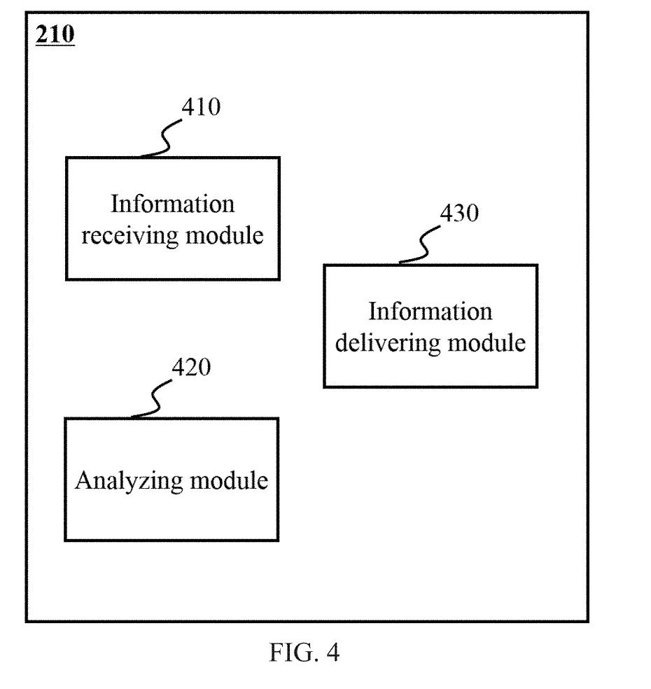

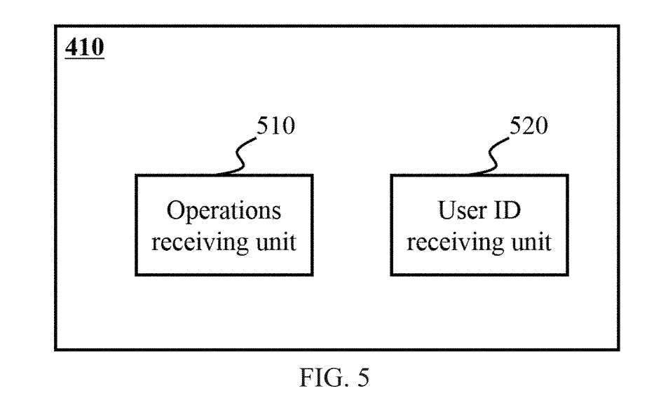

FIG. 4 is a diagram of an exemplary processor 210 according to some embodiments of the present disclosure. Processor 210 may include an information receiving module 410, an analyzing module 420 and an information delivering module 430. Information receiving module 410 may receive the service request from mobile user equipment 130. Information receiving module 410 may also receive information relating to an operation on mobile user equipment 130 indicative of the occurrence of a trigger event (i.e., the user may initiate a service request on mobile user equipment 130) and/or registration information and historical requests of a user (who may be associated with a user ID) from database 150. In some embodiments, information receiving module 410 may receive information from mobile user equipment 130 or database 150 through network interface 230. As shown in FIG. 5, information receiving module 410 may include an operation receiving unit 510 and a user ID receiving unit 520. In some embodiments, user ID receiving unit 520 may receive information relating to historical requests associated with a user ID and/or registration information associated with a user ID from database 150. In some embodiments, the information relating to historical requests associated with the user ID and/or registration information associated with the user II) may be used for determining a promotion such as an amount of a benefit of a coupon. In some embodiments, operation receiving unit 510 may receive information relating to an operation triggering an event relating to a service request from mobile user equipment 130 through network 120. In some embodiments, the information relating to the operation received by operation receiving unit 510 may be used for detecting the trigger event. In some embodiments, a promotion may be determined before a trigger event, and may be stored in storage 220. If processor 210 determines that the information relating to an operation received by operations receiving unit 510 is indicative of a trigger event, the promotion stored in storage 220 may be delivered to mobile user equipment 130.

Historical requests and registration information received by the user ID receiving unit 510 may include demographic feature (DF) associated with the user. DF may be used to identify one or more categories of the user. The historical requests and registration information may also include request statistics (RS) associated with a plurality of historical service requests by the user, and/or expenditure statistics (ES) indicating the expenditure of the historical service requests by the user. DF may include some or all of the registration information associated with a user ID. In some embodiments, the one or more demographic features of the user may include gender, profession, and/or age group. In some embodiments, RS associated with the user may include the number of historical service requests by the user, the number of historical service requests having used at least one promotion, the average mileage of the historical service, and/or starts and destinations of the plurality of historical services. RS may also include city factors associated with the cities in which the historical requests are initiated or the historical services performed. In some embodiments, ES may include the total expenditure of the historical service requests, the average expenditure of the historical service requests, and/or the total amount of promotions (credit or discount) used in the historical service requests.

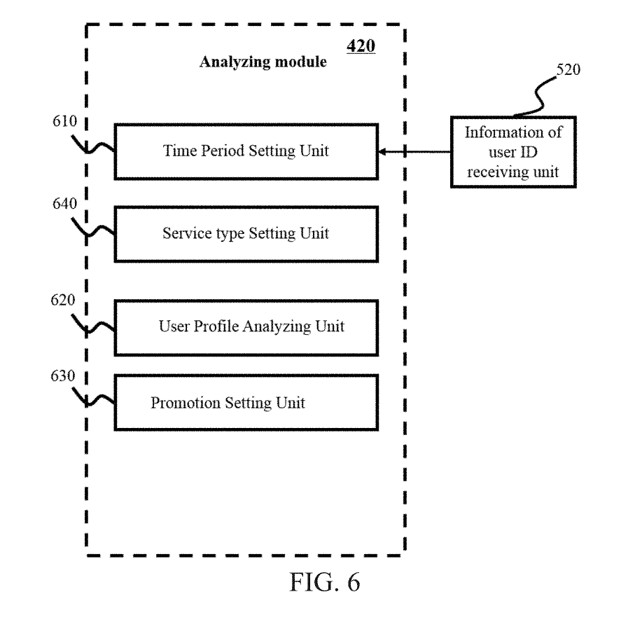

Analyzing module 420 may determine the amount of the benefit of a coupon based on historical requests and/or registration information received from the information receiving module 410. As illustrated in FIG. 6, analyzing module 420 may include a time period setting unit 610, a user profile analyzing unit 620, and a promotion setting unit 630. In some embodiments, historical requests and registration information may be transmitted from user ID receiving unit 520 to time period setting unit 610. Time period setting unit 610 may set one or more time periods for filtering historical requests. In some embodiments, the time periods may be adjusted for different user IDs or under different circumstances. In some embodiments, the time periods of historical requests may be determined according to some preset values that may be stored in storage 220. Time period setting unit 610 may perform as a filter to select the historical request(s) within one or more preset time periods. In some embodiments, time period setting unit 610 working as a filter may be determined in the information receiving module 410, and the data received from user ID receiving unit 520 may be transmitted to user profile analyzing unit 620 directly.

In some embodiments, if server 110 receives a service request, which may be associated with a certain type of service, from a mobile user equipment 130, server 110 may broadcast the service request to a plurality of service providers 140 that can perform the type of service associated with the service request. If the service request is received or other trigger events (e.g., the application at mobile user equipment 130 for requesting a service is launched by the user) is detected by server 110, server 110 may deliver a coupon to mobile user equipment 130. The amount of the benefit of the coupon may be determined according to the registration information and/or data of the historical requests. In some embodiments, the historical requests used for calculating the amount of the benefit of the coupon may be restricted to a certain type of service. For example, when mobile user equipment 130 transmits to server 110 a service request of luxury car service, a coupon may be determined according to the historical requests of luxury car service, but not all types of service. In some embodiments, service type setting unit 640 of analyzing module 420 may filter the historical requests associated with the user (e.g., by matching the user ID) for determining the coupon.

In some embodiments, the coupon may be determined according to the city where the service request is sent or the service is to be performed. Server 110 may determine the city information based on the location information of mobile user equipment 130 it receives. For example, if server 110 receives a service request from mobile user equipment 130, the coupon may be determined according to the historical requests associated with the same city as the current request. Analyzing module 420 may filter the historical requests associated with the user that are associated with the same city as the current request.

User profile analyzing unit 620 may receive information from time period setting unit 610 and generate a user profile. In some embodiments, the user profile may include data for determining a promotion, including, for example, data relating to DF, RS and/or ES. User profile analyzing unit 620 may extract data relating to DF, RS and/or ES from the historical requests received from the time period setting unit 610. The user profile may be transmitted to promotion setting unit 630.

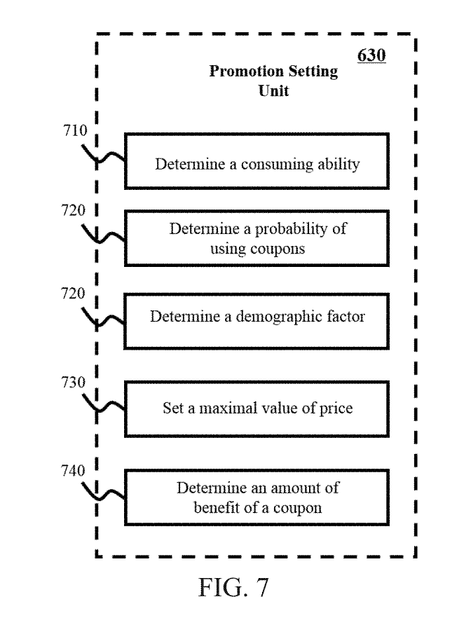

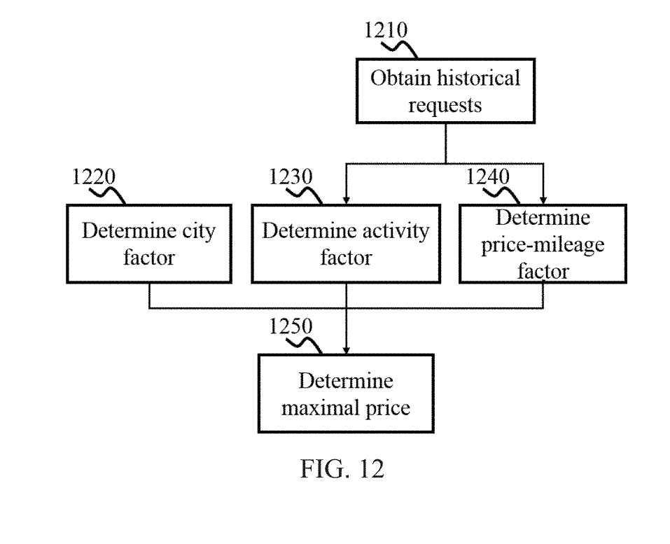

Promotion setting unit 630 may determine the amount of the benefit of a coupon based on the user profile. Promotion setting unit 630 may process data of DF, RS and/or ES. In some embodiments, as illustrated in FIG. 7, promotion setting unit 630 may be configured to determine the consumption ability of the user, the probability of using a coupon, determine a demographic factor, and/or set a maximal value of the price of the service to be performed. In some embodiments, promotion setting unit 630 may determine the consumption ability of the user, the probability of using a coupon, the demographic factor, and/or the maximal value of price of the service based on data of DF, RS and/or ES. Promotion setting unit 630 may also be configured to determine the amount of the benefit of the coupon that is to be delivered to mobile user equipment 130 based on the maximal amount of the price of the service to be performed and at least one of the consumption ability of the user, the probability of using a coupon, or the demographic factor. The maximal amount of the price of the service to be performed may be determined based on an exemplary method illustrated in FIG. 12, which is described in detail below in connection with FIG. 12,

In some embodiments, the consumption ability may be determined according to data of RS and ES. Merely by way of example, the consumption ability may be determined according to the number of the historical service requests associated with the user (or n_{car}) and the total amount of the expenditure of the historical service requests associated with the user (or costₐₗₗ). In some embodiments, the consumption ability C may be determined according to the equation as follows:

$$C = \frac{2}{1 + {e}^{- \frac{\overline{spend}}{80}}} - 1 , \qquad Equation ( 1 )$$

wherein the parameter spend may be determined as follows:

$$spend = \frac{{cost}_{all}}{{n}_{car}^{0.6}} .$$

In some embodiments, the probability of using a coupon may be determined according to data of RS and ES. Merely by way of example, the probability of using a coupon may be determined according to the number of the of historical service requests associated with the user (or n_{car}), the number of the historical service requests for which the user has used at least one coupon (or n_{coupon}), the total amount of the expenditure of the historical service requests associated with the user (or costₐₗₗ), and the total amount of the coupons used for the historical service requests cost_{coupon}. In some embodiments, the probability of using a coupon P may be determined according to the equation as follows:

$$P = 1 - {( 1 - \frac{{n}_{coupon}}{{n}_{car}} * \frac{{cost}_{coupon}}{{cost}_{all}} )}^{2} . \qquad Equation ( 2 )$$

In some embodiments, server 110 may classify the user into a consumer group among a plurality of consumer groups based on one or more features relating to consumption of the user (or the user's consumption feature(s)). In some embodiments, users may be classified into a first consumer group and a second consumer group, using a clustering algorithm such as a K-means clustering algorithm. Consumption features may include a proportion for choosing a particular service type (e.g., an upscale service such as LUX or SUV), expenditure (all the time or within a particular time period), a probability of using a coupon, the total amount of the coupons used, and tips that the user gives. Server 110 may determine the consumption features based on the historical requests associated with the user.

In some embodiments, the first consumer group may be a group of consumers having a high probability of using a coupon and a high total amount of the coupons used. The second consumer group may be a group of consumers having a low probability of using a coupon and a low total amount of the coupons used. The consumers in the first consumer group may be coupon-sensitive consumers having a high probability of using a coupon, while the consumers in the second consumer group may be consumers with a medium or low probability of using a coupon. In some embodiments, for a consumption feature, a feature vector may be determined by server 110, θₖⁱ is denoted as the ith characteristic vector for the kth cluster. The consumption feature represented by θₖⁱ is a member of the multiple features. Server 110 may classify an unknown sample x (e.g., a consumer group) according to one or more feature vectors. In some embodiments, a classification method may be implemented as

$$g = {max}_{k} {\sum }_{i} {e}^{- dist ( x , {θ}_{k}^{i} )} ,$$

wherein g is a degree of membership for the unknown sample x to be assigned to the kth cluster. Server 110 may determine a distance between sample x and the feature vector θₖⁱ. Server 110 may further determine the cluster k corresponding to the maximum of g as the category to which the unknown sample x belongs.

In some embodiments, a coupon to be delivered to mobile user equipment 130 may be a special coupon or an ordinary coupon. In some embodiments, a special coupon may be a coupon delivered during a special promotion such as the spring festival and Christmas. An ordinary coupon may be a coupon delivered to mobile user equipment 130 regardless of any special promotion. In some embodiments, the coupon may be delivered to the user when a trigger event occurs and is detected by server 110. Alternatively, a coupon may be delivered to mobile user equipment 130 when one or more other conditions are met in addition to the detection of a trigger event. In some embodiments, after determining one or more certain conditions have met, server 110 may detect a trigger event from the user for delivering a new coupon. For example, server 110 may generate a coupon and transmit the coupon to mobile user equipment 130 only when the number of the coupons available to the user (e.g., associated with the user account) is lower than a threshold and a trigger event is detected. As another example, server 110 may determine that the coupons of the user will expire in a few days, and upon detecting a trigger event, server 110 may generate a coupon and transmit it to mobile user equipment 130.

In some embodiments, a trigger event may be initiated by a user or a third party. Server 110 may register User A with a unique ID and record User A when User A logs into server 110 (or other appropriate server hosting the log-in service). Server 110 may generate a list of promotion strategies according to the user profile. Merely by way of example, a promotion strategy generated by server 110 is shown in Table 1:

TABLE 1

| User Profile Type | Promotion Strategy |
|---|---|
| User Profile Type I: | [symbol] 2 coupon |
| Weekly service requests is more than 3; | |
| each payment is more than [symbol] 20; or | |
| the residential place is in Beijing | |
| User Profile Type II: | [symbol] 10 coupon |
| Average weekly service requests is more than 5; | |
| each payment is more than [symbol] 20; or | |
| the residential place is in Shanghai. | |
| User Profile Type III: | 5 point Alipay credit |
| Average weekly service requests is less than 1; | |
| each payment is less than [symbol] 30; or | |
| the residential place is in Chengdu. | |

As indicated by the Table 1, server 110 may determine a coupon to be delivered to the user according to a promotion strategy specifying user profile types and their corresponding coupons within a predetermined time period. If the user initiating a trigger event is determined by server 110 as a User Profile Type I user, server 110 may send a promotion including a “ [symbol] 2coupon” to mobile user equipment 130 (randomly, at a predetermined time, or upon detecting a trigger event).

Alternatively, if the user initiating a trigger event is determined by server 110 as a User Profile Type I and III user, server 110 may send a promotion including “ [symbol] 2 coupon” and “5 point Alipay credit” to mobile user equipment 130 (randomly, at a predetermined time, or upon detecting the trigger event).

Alternatively, if a user initiating a trigger event is determined by server 110 as none of User Profile Type I user, User Profile Type II user or User Profile Type III user, server 110 may send no promotion to mobile user equipment 130.

In some embodiments, a trigger event may be initiated by a third party (e.g., an e-commerce shop) when a user conducts business at the third party. Server of the third party may register User B with a unique ID and record User B when User B purchases a merchandise using a coupon at the e-commerce shop (or other appropriate server hosting the e-commerce service). When the server of third party initiates a certain trigger event, for example, requesting a connection with server 110 in system 100, server 110 may obtain information relating to promotion for User B from the server of third party when server 110 establishes connection with server of the third party.

In some embodiments, the information relating to promotion for User B may be “ID and usage of coupon”. If the ID of User B is already registered and stored in server 110, server 110 may determine user profile associated with the ID of User B. If there is a promotion strategy for delivering coupons in server 110 for user profile associated with the ID of User B, server 110 may send a coupon to mobile user equipment 130 (randomly, at a predetermined time, or upon detecting the trigger event).

Alternatively, the information relating to promotion for User B may be “ID and usage of coupon”. If the ID of User B is already registered and stored in server 110, server 110 may determine user profile associated with the ID of User B. If there is no promotion strategy for delivering coupons in server 110, server 110 may generate a list of promotion strategies for delivering coupons.

In some embodiments, besides the consumption ability and probability of using coupons, the amount of coupon may also be determined according to a demographic factor of a user. The demographic factor may be determined according to one or more demographic features of the user such as the user's gender, profession, and age. Demographic features may also include the age group the user belongs to. Merely by way of example, the demographic factor may be set as 0.9 if the user is a businessman or 0.7 if the user is a teacher. The demographic factor may be assigned based on a value determination strategy. The value determination strategy may be stored in storage 220 accessible to server 110. The value determination strategy may be adjusted by server 110. In some embodiments, the value assignment strategy may be a lookup table stored in storage 220, which may specify demographic features, parameters of the demographic features, and the corresponding demographic factor values.

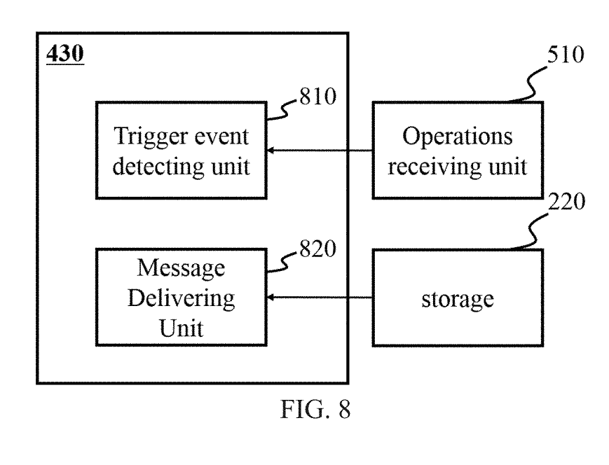

FIG. 8 is a diagram of an exemplary information delivering module 430 of processor 210 according to some embodiments of the present disclosure. As illustrated in FIG. 8, the information delivering module 430 may include a trigger event detecting unit 810 and a message delivering unit 820. In some embodiments, trigger event detecting unit 810 may receive information from the operations receiving unit 510 and detect whether an operation is a trigger event or not. In some embodiments, trigger event detecting unit 810 may detect whether an operation is a trigger event based on one or more trigger event templates. For example, if trigger event detecting unit 810 receive information relating to an operation at mobile user equipment 130 from operation receiving unit 510, trigger event detecting unit 810 may compare the operation with the trigger events templates. In some embodiments, the trigger events templates may be stored in storage 220 and adjusted by server 110.

The message delivering unit 820 may deliver a message including a promotion to the mobile user equipment 130. The promotion may be a coupon or voucher, with a discount, a credit, or a combination thereof. In some embodiments, the promotion may be a coupon with some benefit (e.g., a certain amount of a credit or discount). In some embodiments, the promotion may be transmitted to storage 220 from promotion setting unit 630, stored in storage 220, and transmitted to the message delivering unit 820 when a trigger event is detected.

In some embodiments, a coupon detecting unit (not shown in FIG. 8) may detect the coupons that the user holds (by, for example, determine the coupons associated with the user account). In some embodiments, the coupon detecting unit may allow a coupon to be delivered only if the number of the coupons that the user holds is equal to or less than a threshold number.

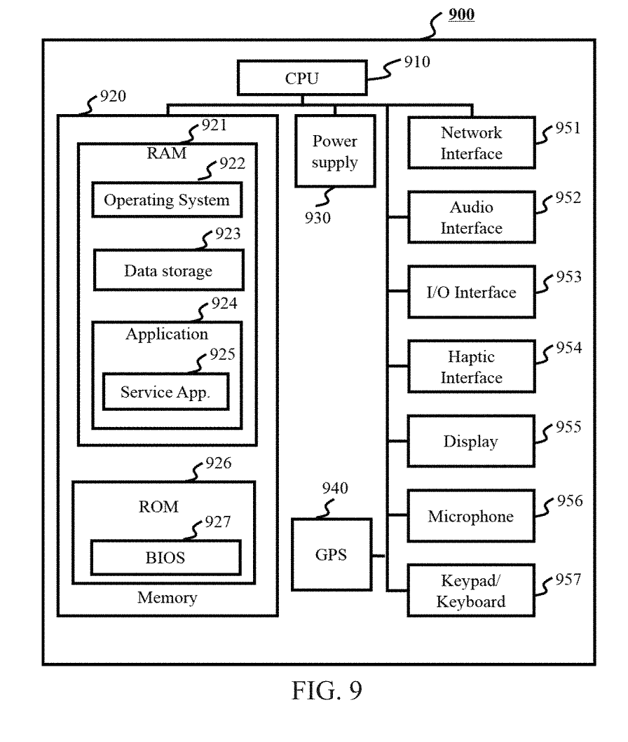

FIG. 9 is a block diagram illustrating an exemplary computing device 900, on which mobile user equipment 130 or service provider 140 may be implemented to perform the functions of mobile user equipment 130 or service provider 140 disclosed in this application. Computing device 900 may include a processing unit (also referred to herein as CPU) 910, a memory 920, a power supply 930, a global positioning system (GPS) module 940. CPU 910 may process information from other components of computing device 900 or from other modules or units in system 100. For example, CPU 910 may control memory 920 or data storage medium 923 to store information. Memory 920 may include a random access memory (RAM) 921 and a read-only memory (ROM) 926. RAM 921 may store some information including an operating system (OS) 922, one or more application programs 924 or data 923. Operating system 922 may include iOS, Android, Windows Phone, or the like. For a transportation system, application program 924 may include a transportation service application program 925. Application program 924 may be executed by CPU 910. ROM 926 may include a basic input/output system (BIOS) 927, Power supply 930 may supply electric energy to computing device 900. Global positioning system (GPS) module 940 may provide a location of computing device 900.

In some embodiments, the computing device 900 may also include a network interface 951. Network interface 951 may facilitate communications between computing device 900 and network 120. For example, a service request from mobile user equipment 130 may be transferred to server 110 through network interface 951. As another example, service provider 140 may accept the order received from server 110 through network interface 951. A location of mobile user equipment 130 or service provider 140 may be transferred to server 110 through network interface 951.

In some embodiments, computing device 900 may include an audio interface 952. Audio interface 952 may take various audio inputs and convert them into digital data. In some embodiments, computing device 900 may include an input/output interface (I/O interface) 953 in communication with external I/O devices (e.g., a mouse, a keyboard, a monitor, a printer, or the like) and configured to receive input from and output information to the user or the driver. In some embodiments, computing devices 900 may include a microphone 956. In some embodiments, computing devices 900 may include a keypad or keyboard 957. In some embodiments, computing devices 900 may include a display 955. In some embodiments, computing device 900 may also include a haptic interface 954.

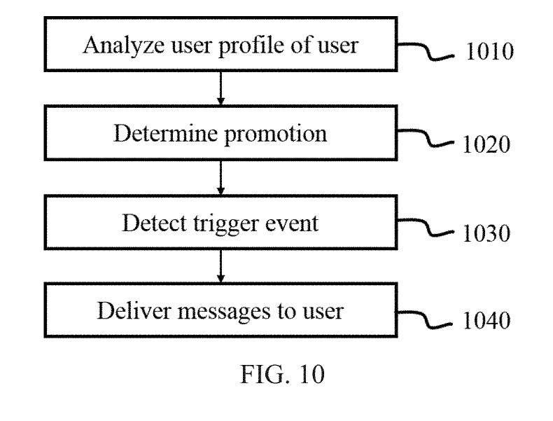

FIG. 10 is a flowchart of an exemplary process for determining a promotion and delivering a message including the promotion. The process may be performed by processor 210 of server 110 based on instructions stored in storage 220. In 1010, processor 210 in server 110 may establish a communication with mobile user equipment 130 via network 120. Sever 110 may also identify a user identity associated with a user of a service from mobile user equipment 130. Processor 210 may obtain and analyze the user profile associated with the user identity. Information included in the user profile may be used to determine the promotion. For example, the user profile may include data of DF, RS and/or ES. In some embodiments, DF may be used to identify one or more categories of the user. DF may include some or all of the registration information associated with a user ID. In some embodiments, the one or more categories of the user may include gender, profession, and/or age group. In some embodiments, RS associated with the user may include the number of historical service requests by the user, the number of historical service requests having used at least one promotion, the average mileage of the historical service, and/or starts and destinations of the plurality of historical services. RS may also include city factors associated with the cities in which the historical requests are initiated or the historical services performed. In some embodiments, ES may include the total expenditure of the historical service requests, the average expenditure of the historical service requests, and/or the total amount of promotions (credit or discount) used in the historical service requests.

In 1020, a promotion may be determined by processor 210. In some embodiments, processor 210 may be configured to determine the consumption ability of the user, the probability of using a coupon, determine a demographic factor, and/or set a maximal value of the price of the service to be performed. Processor 210 may further determine a promotion based on the determined consumption ability of the user, probability of using a coupon, demographic factor, and/or maximal value of the price of the service to be performed. In some embodiments, processor 210 may determine the amount of the benefit of the coupon that is to be delivered to mobile user equipment 130 (i.e., the promotion to be delivered to the user) based on the maximal amount of the price of the service to be performed and at least one of the consumption ability of the user, the probability of using a coupon, or the demographic factor. In some embodiments, information relating to the promotion information about the amount of the benefit of the coupon may be stored in storage 220.

In 1030, a trigger event may be detected by processor 210. Trigger event detecting unit 810 of processor 210 may receive information from operations receiving unit 510 and detect whether an operation is a trigger event or not. In some embodiments, trigger event detecting unit 810 may detect whether an operation is a trigger event based on one or more trigger event templates. For example, if trigger event detecting unit 810 receive information relating to an operation at mobile user equipment 130 from the operation receiving unit 510, trigger event detecting unit 810 may compare the operation with the trigger events templates. In some embodiments, the trigger events templates may be stored in storage 220 and adjusted by server 110. In 1040, processor 210 may generate a message including the determined promotion and deliver the message to mobile user equipment 130.

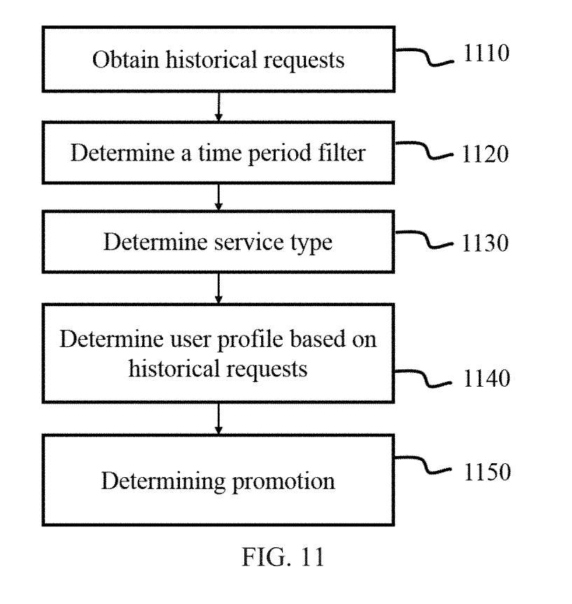

FIG. 11 is a flowchart of an exemplary process for determining a user profile and determine the promotion based on the user profile. In 1110, analyzing module 420 of processor 210 may obtain historical requests associated with the user. In sonic embodiments, the historical requests may be stored in database 150 and accessible to server 110 (and processor 210).

In 1120, time period setting unit 610 of analyzing module 420 may determine a time period filter for filtering the historical requests obtained in 1110. For example, time period setting unit 610 may determine a first time period and a second time period as a time period windows for the time period filter. Analyzing module 420 may then select the historical requests in the time period window. Alternatively, analyzing module 420 may first determine a time period filter and then obtain the historical requests within the time period specified by the determined time period filter from database 150 directly.

Alternatively or additionally, in 1130, processor 210 may determine the service type of the current request. Processor 210 may also filter the historical requests (the historical requests obtained in 1110 or the filtered historical requests by the time period filter obtained in 1120) according to the determined service type, and obtain the historical requests that have the same type of service as the current service request.

Alternatively or additionally, in 1140, processor 210 may determine a user profile based on the information relating to the historical requests (e.g., the historical requests obtained in 1110, the filtered historical requests by the time period filter obtained in 1120, or the filtered historical requests obtained in 1130). In some embodiments, the user profile may include data of DF, RS or ES, which may be used for determining the promotion. In some embodiments, the data of DF, RS or ES may be used for determining a maximal value of price and/or weighting factors such as the consumption ability, probability of using a coupons, and demographic factor(s).

In some embodiments, processor 210, in 1150, may determine the promotion based on the information included in the user profile. Alternatively or additionally, processor 210 may determine the promotion based on the historical requests the historical requests obtained in 1110, the filtered historical requests by the time period filter obtained in 1120, or the filtered historical requests obtained in 1130).

FIG. 12 is a flowchart of an exemplary method for determining the maximal value of price according to some embodiments of the present disclosure. In some embodiments, processor 210 may determine the maximal value of price of the service to be performed based, at least in part, on the city factor, activity factor, and/or price-mileage factor.

Processor 210, in 1210, may obtain a plurality of historical requests associated with the user. The historical requests may be the historical requests obtained by processor 210 in 1110, the filtered historical requests by the time period filter obtained in 1120, or the filtered historical requests obtained in 1130 described elsewhere in this disclosure.

In 1230, processor 210 may determine an activity factor for the user based on the historical requests. The activity factor may be a factor indicating the user's frequency of requesting services. In some embodiments, the activity factor may be determined according to the number of the historical requests (e.g., the historical requests obtained by processor 210 in 1110, the filtered historical requests by the time period filter obtained in 1120, or the filtered historical requests obtained in 1130). In some embodiments, the activity factor may be determined based on the number of the historical requests within a time window. In some embodiments, an activity changing factor may be used with the activity factor for determining the maximal price. Alternatively, the activity changing factor may be determined according to the number of the historical requests within two or more time windows. In some embodiments, the two or more time windows may have a same time frame or different time frames. The activity changing factor may be determined according to the equation as follows:

$$AC = \frac{α}{1 + x} , \qquad Equation ( 3 )$$

wherein AC is the activity changing factor, α is a constant,

$$x = \frac{{V}_{2} - {V}_{1}}{{V}_{1}} ,$$

wherein V₁ is the activity factor of the historical requests in the first time window and V₂ is the activity factor of the historical requests in the second time window. In some embodiments, the first time window may be prior to the second time window. In some embodiments, the first time window may have a same length as the second time window.

Alternatively or additionally, processor 210, in 1240, may determine a price-mileage factor based on the historical requests. The price-mileage factor may include a price factor and a mileage factor. In some embodiments, the price factor may be determined according to the average amount of the expenditure of the historical requests, and the mileage factor may be determined according to the average mileage of the historical requests. In some embodiments, the price factor may be determined according to the equation as follows:

$$\{ \begin{matrix}PF = \frac{β}{1 + ln y} \\ PF = 1 , y = 0\end{matrix} , \qquad Equation ( 4 )$$

wherein PF is the price factor, β is a constant, and y is the average amount of the expenditure of the historical requests. The price factor may be indicative a sensitivity of the user to the price of service. In some embodiments, the mileage factor may be determined according to the equation as follows:

$$\{ \begin{matrix}MF = \frac{γ}{1 + ln z} \\ MF = 1 , z = 0\end{matrix} , \qquad Equation ( 5 )$$

wherein MF is the mileage factor, γ is a constant and z is the average mileage of the historical requests.

Alternatively or additionally, processor 210, in 1220, may determine a city factor. The city factor may be determined according to the location information included in the current request or information obtained from mobile user equipment 130 (e.g., through the location information of mobile user equipment 130). For example, the city where the service request is initiated or the service is to be performed may be obtained, and the city factor corresponding to the city may be determined according to a lookup table specifying a plurality of cities and their corresponding city factors. In some embodiments, the lookup table may be stored in storage 220 and/or database 150.

In 1250, processor 210 may determine the maximal value of price of the service to be performed according to the city factor (determined in 1220), activity factor (determined in 1230), or price-mileage factor (determined in 1240), or any combination thereof Merely by way of example, the maximal value of price may be determined according to the equation as follows:

MV=CF*V₂*AC*PF*MF*y Equation (6),

wherein MV is the maximal value of price, CF is a city factor, V₂ is the activity factor of the historical requests in the second time window, AC is the activity changing factor, PF is the price factor, MF is the mileage factor, and y is the average amount of the expenditure of the historical requests.

As described elsewhere in this disclosure, the amount of the benefit of a coupon may be determined according to the consumption ability of the user, the probability of using a coupon, the demographic factor, and/or the maximal value of price. Merely by way of example, the amount of the benefit of a coupon may be determined according to the equation as follows:

AB=MV*f₁(C)*f₂(P)*f₃(D) Equation (7),

wherein MV is the maximal value of price, AB is the amount of the benefit of a coupon, D is the demographic factor, f₁(C) is a function of consumption ability, f₂(P) is a function of probability of using a coupon, f₃ (D) is a function of demographic factor. In some embodiments, if a factor the consumption ability of the user, the probability of using a coupon, the demographic factor, or the maximal value of price) is ignored for the purposes of determining the amount of the benefit, the function of the factor may be set as 1. Merely by way of example, the amount of the benefit of a coupon may be determined based on two factors—the maximal value of price and consumption ability, the amount of the benefit may be determined according to the equation AB=MV(1−C), wherein MV is the maximal value of price and C is the consumption ability. In other words, f₁(C)=1−C, f₂(P)=1, and f₃(D)=1.

It should be noted that the functions above are for the purpose of illustration and description only and are not intended to limit the scope of the present disclosure. In some embodiments, the historical requests may be initiated in different cities and/or with different service types. When a trigger event occurs in a city with a certain service type, server 110 may deliver a coupon with some benefit (e.g., a certain amount of a credit or discount) that is determined according to registration information and historical requests occurred in the same city and with the same service type. If a trigger event such as launching a service application does not indicate a service type, a coupon that is determined according to the historical requests with a service type that the user requested most in the historical requests may be delivered to mobile user equipment 130.

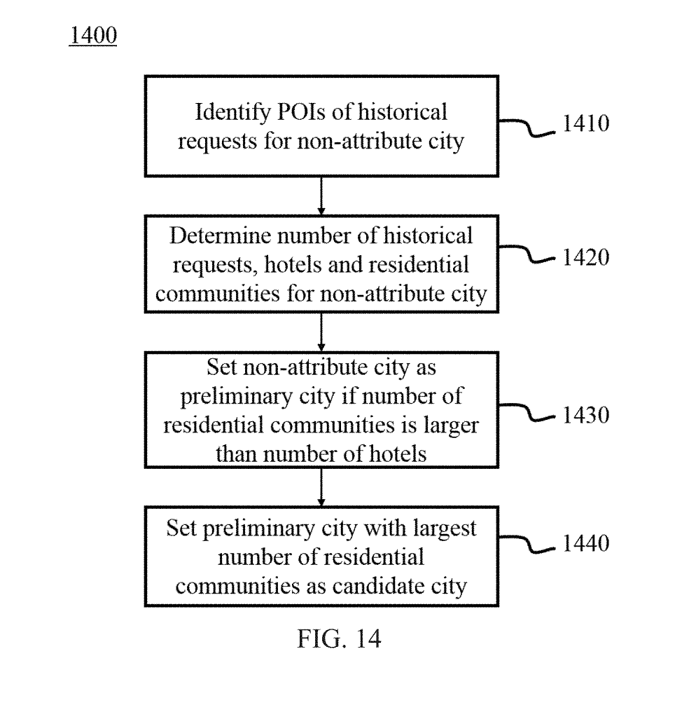

Demographic factor may be determined according to one or more demographic features such as gender, residential city, profession, and/or age group. The user's residential city and profession may be determined according to the processes 1400-1600 illustrated in FIGS. 14-16 and described elsewhere in this disclosure. Merely by way of example, the demographic factor may be set as 0.9 if the user's profession is a businessman, or 0.7 if the user is a teacher. The demographic factor may be assigned based on a value determination strategy. The value determination strategy may be stored in storage 220 accessible to server 110. The value determination strategy may he adjusted by server 110. In some embodiments, the value assignment strategy may be a lookup table stored in storage 220, which may specify demographic features, values of the demographic features, and the corresponding demographic factor values.

In some embodiments, the demographic factor may be determined according to a lookup table stored in storage 220 and/or database 150. Merely by way of example, Table 2 is a lookup table that may be used by processor 210 for determining the demographic factor based two demographic features profession and age group to which the user belongs.

TABLE 2

| Demographic | Demographic factor | | | |
|---|---|---|---|---|
| Feature | businessman | teacher | student | . . . |
| Age group (under 30) | 0.9 | 0.7 | 0.8 | . . . |
| Age group (30-40) | 0.8 | 0.75 | 0.75 | . . . |
| . . . | . . . | . . . | . . . | . . . |

In some embodiments, the lookup table may be an n-dimension chart, wherein 1≤n≤the number of demographic features. The lookup table may be adjusted or updated by processor 210.

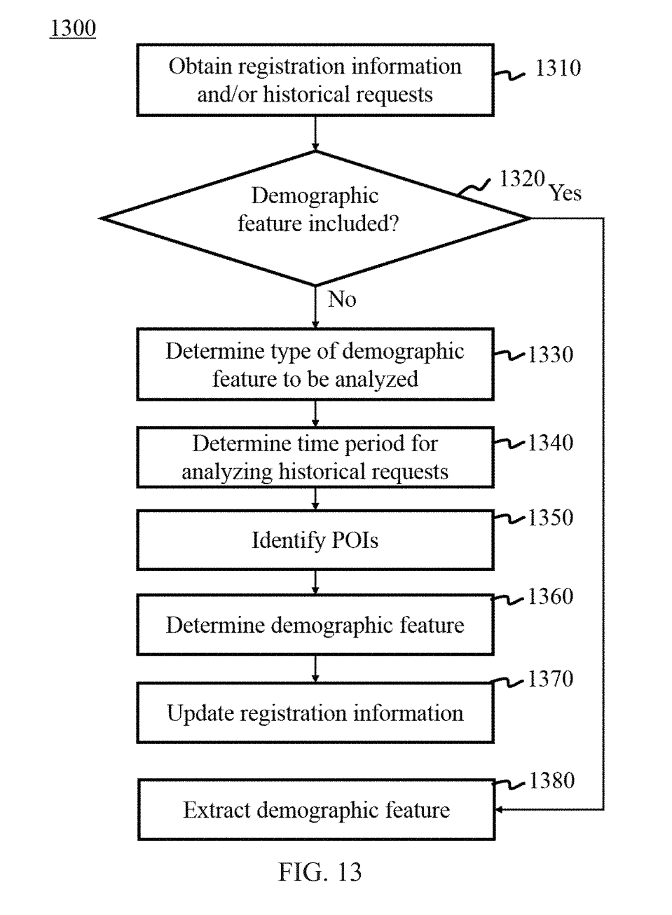

In some embodiments, processor 210 may determine a demographic feature of the user based on an exemplary process 1300 illustrated in FIG. 13. In 1310, registration information and/or historical requests associated with the user ID may be obtained by user ID receiving unit 520 of the information receiving module 410. In 1320, processor 210 may determine whether the registration information includes the demographic feature. The demographic feature that processor 210 is looking for may be a particular demographic feature type (e.g., the profession or age group) or any demographic feature to be used for determining the promotion (the method of determining the promotion based, at least in part, on one or more demographic features is described elsewhere in this disclosure). If processor 210 determines that the demographic feature is included in the registration information, processor 210 may, in 1380, extract the demographic feature (the “Yes” arrow out of diamond 1320). In some embodiments, the registration information of the user may include a demographic feature. For example, the user may provide server 110 with such information when registering his or her account (at mobile user equipment 130 or other device). As another example, processor 210 may have previously determined the demographic feature (by, for example, process 1300). On the other hand, if processor 210 determines that the demographic feature is missing, processor 210 may, in 1330, determine the type of the demographic feature. For example, if processor 210 determines that it needs the profession of the user (i.e., a type of demographic feature) for determining the demographic factor, processor 210 determine the type of demographic feature as “profession.”

In 1340, processor 210 may optionally determine a time period for selecting the historical requests to be analyzed. In 1350, processor 210 may analyze the historical requests (the selected historical requests obtained in 1340 or the historical requests obtained in 1310) and identify the points of interest (or POIs) included in the historical requests. The POI in this application refers to a starting point or a destination in a request, and may include information relating to commercial, residential, attraction, and/or residential place(s) that is located in a particular point on the Earth. The POIs may be classified into various types such as school, hospital, railway station, airport, company, residential community, hotel scenic, spot, etc. In some embodiments, the identification of the POIs may be performed by user profile analyzing unit 620 of analyzing module 420.

In 1360, processor 210 may determine the demographic feature based on the POIs. For example, if the POIs included in the history requests are business places, processor 210 may determine that the user might be a businessman. As another example, if a POI included in the historical requests that the user regularly visited or departed (as a destination or starting point) is a company, it is likely that the POI is the user's workplace, and processor 210 may determine that the user is a businessman (or a teacher if the POI is an elementary school). In 1370, processor 210 may update the user's registration information for the future use. In some embodiments, processor 210 may determine whether there is more demographic feature to be obtained. If so, processor 210 may repeat the steps 1320 through 1370 (or 1380) to determine the demographic feature.

In some embodiments, the profession of the user (i.e., a demographic feature of the user) may be determined according to exemplary processes illustrated in FIGS. 14-16. The term “profession” used in this disclosure may be a job (or a type thereof) the user holds. In some embodiments, the user's profession may be determined as a tourist when the user requests the service, although the user may have a job as teacher. For example, the user may be a teacher in the user's residential city, while he or she may be determined as a tourist when the user requests a service in another city.

In some embodiments, in 1410, processor 210 may identify POIs from historical requests associated with one or more non-attribute cities. The user's attribute city refers to the city in which the user's registered phone number belongs. A non-attribute city is a city that is not the attribute city. The user's attribute city may be determined according to, for example, the area code or location identification code of the registered phone number.

In 1420, for each of non-attribute cities (or a portion of non-attribute cities), processor 210 (e.g., user profile analyzing unit 620) may determine the number of historical requests associated with the non-attribute city, and/or the number of hotels (including, for example, hotels, motels) and the number of residential communities in the non-attribute city (or part thereof).

In 1430, for a non-attribute city, processor 210 may determine whether the number of residential communities is larger than the number of hotels in the non-attribute city. If so, processor 210 may set the non-attribute city as a preliminary residential city of the user. Processor 210 may repeat step 1430 for each of non-attribute cities (or a portion of non-attribute cities) and determine a plurality of preliminary residential cities.

In 1440, processor 210 may determine which preliminary residential city has the largest number of residential communities among all preliminary residential cities. Processor 210 may also set the preliminary residential city having the largest number of residential communities as a candidate city of the user.

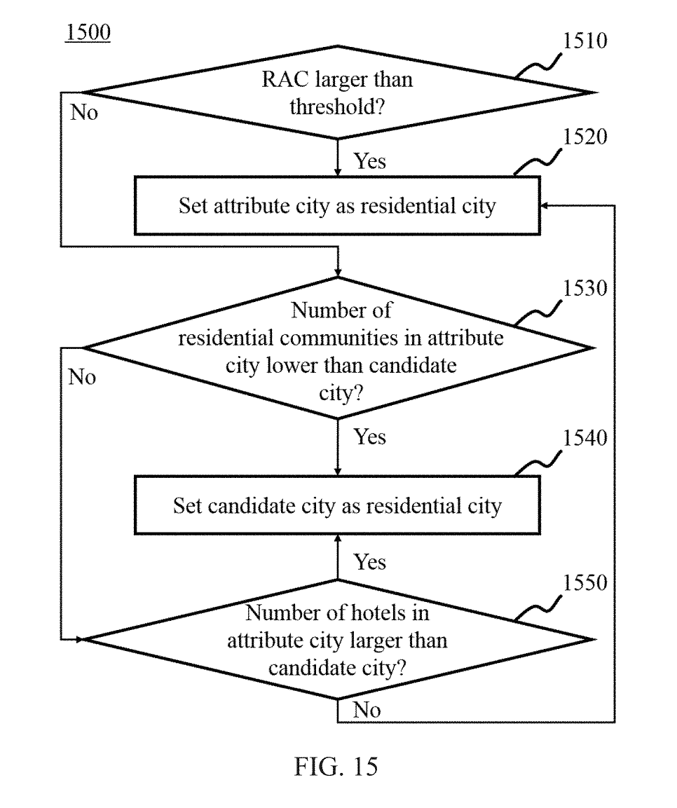

FIG. 15 is a flowchart of an exemplary process for determining the user's residential city. In 1510, processor 210 may determine a ratio of the number of historical requests associated with the attribute city to the number of historical requests associated with the candidate city (or RAC). Processor 210 may further determine whether the RAC is larger than a second threshold. If so (the Yes arrow out of diamond 1510 in FIG. 15), processor 210 may, in 1520, determine that the attribute city is the user's residential city. On the other hand, if not (the No arrow out of diamond 1510), processor 210 may, in 1530, determine whether the number of residential communities in the attribute city is lower than the number of residential communities in the candidate city. If so (the Yes arrow out of diamond 1530 in FIG. 15), processor 210 may, in 1540, determine that the candidate city is the user's residential city. On the other hand, if not (the No arrow out of diamond 1530), processor 210 may, in 1550, determine whether the number of hotels in the attribute city is larger than the number of hotels in the candidate city. If so (the Yes arrow out of diamond 1550 in FIG. 15), processor 210 may, in 1540, determine that the candidate city is the user's residential city. On the other hand, if not (the No arrow out of diamond 1550), processor 210 may, in 1520, determine that the attribute city is the user's residential city.

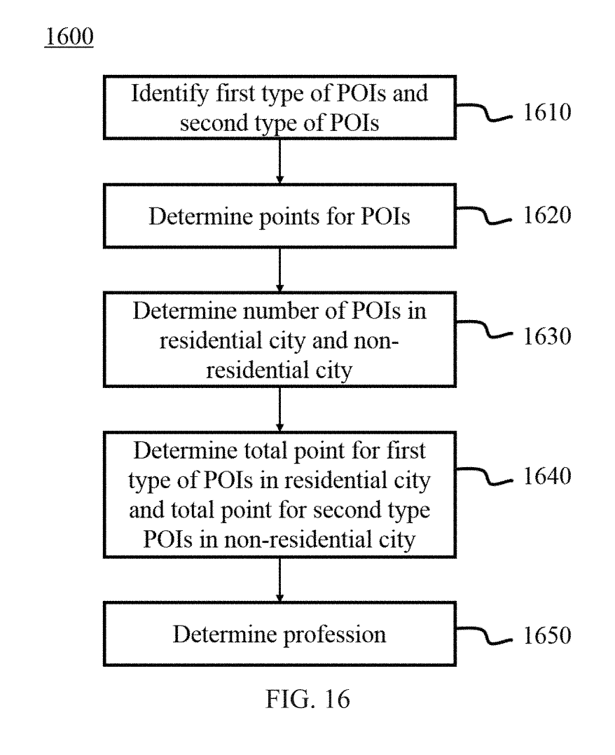

FIG. 16 is a flowchart of exemplary process for determining the user's profession based on the historical requests in the residential city and one or more non-residential cities. The user's residential city and non-residential cities may be determined based on processes 1400 and 1500 discussed above.

In 1610, processor 210 may determine a first type of POIs and a second type of POIs based on a POI classification strategy. In some embodiments, the POI classification strategy may be adjusted for determining different professions and categories of the user's demographic features. The POI classification strategy may be stored in storage 220 or database 150 accessible to processor 210. In some embodiments, the first type of POIs may include public transportation such as airport, subway station, bus station, and railroad station. In some embodiments, the second type of POIs may include places such as company, public community, residential community, hotel, scenic site, airport, and railway station.

In 1620, processor 210 may determine point for each of the POIs identified. In some embodiments, the point for a POI may be stored in storage 220 and/or database 150. The points for the POIs may be adjusted by server 110. Merely by way of example, Table 3 below shows the points for the POIs including airport, company, railroad station, and scenic sites.

TABLE 3

| POI | Airport | Company | Railroad station | Scenic sites | Others |
|---|---|---|---|---|---|
| Point | 2 | 5 | 1 | 5 | 0.1 |

In 1630, processor 210 may determine the number of POIs in the user's residential city and one or more non-residential cities based on the historical requests. Merely by way of example, Table 4 below shows the number of the first type of POIs (i.e., public transportations, including airport and railroad station) in residential city.

TABLE 4

| POI | Airport | Railroad station |
|---|---|---|
| Visiting times | 5 | 10 |

In 1640, processor 210 may determine the total points for the first type of POIs and the second type of POIs. In some embodiments, processor 210 may determine the total point for the first type of POIs in the user's residential city and the total point for the second type of POIs in the user's one or more non-residential cities. Merely by way of example, a total point for the first type of POIs in the user's residential city (shown in Table 4) may be 5*2+10*1=20. In some embodiments, the total point for the first type of POIs may be determined based on the points for the first type of POIs in the residential city and one or more non-residential cities. The total point for the second type of POIs may be determined based on the points for the second type of POIs in the residential city and one or more non-residential cities.

In 1650, processor 210 may determine a profession of the user according to the total point for the first type of POIs and total point for the second type of POIs. In some embodiments, processor 210 may determine the profession based on the total point for the first type of POIs in the residential city and the total point for the first type of POIs and second type of POIs for the one or more non-residential cities. In some embodiments, a user may be classified as a businessman if the total point for the first type of POIs are larger than a third threshold. In some embodiments, the user may be classified as a tourist if the total point for the second type of POIs are larger than a fourth threshold. In some embodiments, the third and fourth thresholds may be adjustable and stored in storage 220.

The following examples are provided merely for the purposes of describing particular exemplary embodiments and are not intended to be limiting the scope of the disclosure. Table 5 shows an exemplary record of historical requests for a user with a use ID P1. For illustration purposes, the details of the historical requests are omitted.

TABLE 5

| | | POI of | POI of | Attribute |
|---|---|---|---|---|
| User ID | City | starts | destination | city |
| P1 | 1 | Business | Hotel | 29 |
| | | building | | |
| P1 | 1 | Hotel | Business | 29 |
| | | | building | |
| P1 | 1 | Hotel | Subway | 29 |
| | | | station | |
| . . . | . . . | . . . | . . . | . . . |
| P1 | 29 | Residential | Coach | 29 |
| | | community | station | |
| P1 | 4 | Hospital | Residential | 29 |
| | | | community | |
| P1 | 4 | Residential | Airport | 29 |
| | | community | | |
| P1 | 4 | Mall | Residential | 29 |
| | | | community | |

As shown in Table 5, the user initiates historical requests in three cities, namely, 1, 4, and 29. The profession of the user may he determined according to the processes 1400-1600 (illustrated in FIGS. 14-16 and described elsewhere in this disclosure). For example, a total number of hotels, residential communities, and the number of historical requests may be determined by the server 110. The results are shown in Table 6 as an example. The number of residential communities are larger than the number of hotels in both city 1 and 4. Thus city 1 and 4 are both preliminary residential cities. Further, the number of residential communities in city 4 is larger than that in city 1. Thus the city 4 may be determined as the candidate city.

TABLE 6

| | | Residential | Number of |
|---|---|---|---|
| City | Hotels | communities | requests |
| 1 | 6 | 9 | 56 |
| 4 | 1 | 20 | 46 |
| 29 | 0 | 1 | 1 |

The user P1's residential city may be determined according to process 1500 (illustrated in FIG. 15). For example, the RAC for city 4 and city 29 is determined for setting the residential city between city 4 and city 29. If the second threshold is 0.4 and the RAC equals to 1/46, the RAC is smaller than the second threshold. Further, the number of residential communities in city 4 is larger than that in city 29. Accordingly, city 4 may he determined as the residential city.

The profession of the user may be determined according to the total point for the first type of POIs and the total point for the second type of POIs. For the residential city 4, the visiting times for the airport and the railroad station are 9 and 2, respectively. Thus, the point for the first type of POIs may be determined as 2*9+1*2=20, and the point for the second type of POIs may be determined as 2*9+1*2=20, For the non-residential cities 1 and 29. the visiting times for the company, airport, and other places are 36, 1, and 72, respectively. Thus, the point for the first type of POIs may be determined as 36*5+1*2+72*0.1=189.2, the point for the second type of POIs may be determined as 1*2+72*0.1=9.2. The total point for the first type of POIs are 20+189.2=209.2, and the total point for the second type of POIs are 20+9.2=29.2. The first type of POIs may be more related to a businessman, while the second type of POIs may be more related to a tourist. Accordingly, this user may be determined as a businessman according to a comparison between the total points for the first type of POIs and the total points for the second type of POIs.

1. A system comprising:
a bus;
at least one storage medium electronically connected to the bus, comprising a set of instructions for an on-demand transportation service; and
logic circuits electronically connected to the at least one storage medium via the bus, wherein during operation, the logic circuits load the set of instructions and:
establish a communication with a mobile device via a network;
identify a user identity associated with a user of a service from the mobile device;
obtain electronic signals from the bus, the electronic signals including a user profile associated with the user identity;
identify a trigger event indicating an intention of the user to initiate a service request for a service from the mobile device;
determine, based on the user profile and the trigger event, a promotion; and
generate a message relating to the promotion to be sent to the mobile device.

2. The system of claim 1, wherein the user profile includes at least one of a demographic feature associated with the user, request statistics associated with a plurality of historical service requests by the user, or expenditure statistics associated with expenditure of the plurality of historical service requests.

3. The system of claim 2, wherein the logic circuits further:
obtain electronic signals from the bus, the electronic signals including a plurality of historical service requests associated with the user;
identify a plurality of points of interest associated with the plurality of historical service requests, and
determine the demographic feature based on the identified plurality of points of interest.

4. The system of claim 2, wherein the demographic feature comprises at least one of:
one or more genders;
one or more professions; or
one or more age groups.

5. (canceled)

6. The system of claim 4, wherein the logic circuits further:
identify a residential city and a non-residential city;
determine a first type of points of interest and a second type of points of interest;
determine a number of the first type of points of interest associated with the residential city and a number of the second type of points of interest associated with the non-residential city; and
determine the one or more professions based on the number of the first type of points of interest associated with the residential city and the number of the second type of points of interest associated with the non-residential city.

7. The system of claim 6, wherein the logic circuits further:
identify an attribute city and a non-attribute city associated with the user;
determine a number of points of interest associated with the attribute city and a number of points of interest associated with the non-attribute city; and
compare the number of points of interest associated with the attribute city and the number of points of interest associated with the non-attribute city; and
select, from the attribute city and the non-attribute city, a city as the residential city associated with the user based on a result of the comparison.

8. The system of claim 7, wherein the identified non-attribute city is selected from a plurality of non-attribute cities and the logic circuits further:
identify a plurality of non-attribute cities;
determine a number of residential communities and a number of hotels associated with each of the plurality of non-attribute cities; and
select, among the plurality of non-attribute cities, the identified non-attribute city based on the number of residential communities and the number of hotels associated with each of the plurality of non-attribute cities.

9. The system of claim 2, wherein the expenditure statistics comprises at least one of
an amount of the expenditure of the plurality of historical service requests;
an average amount of the expenditure of the plurality of historical service requests; or a total amount of a plurality of used promotions in the plurality of historical service requests.

10. (canceled)

11. The system of claim 1, wherein the logic circuits is configured to identify the trigger event by identifying that a program on the mobile device is started, or that login information of a program on the mobile device is entered, and wherein the program relates to the service request.

12. The system of claim 1, wherein the promotion comprises at least one of a voucher, a discount, or a credit.

13. (canceled)

14. (canceled)

15. A method configured to operate an online on-demand transportation service on at least one electronic device having logic circuits, at least one storage medium, and a communication platform connected to a network, comprising:
establishing, by the logic circuits, a communication with a mobile device via a network;
identifying, by the logic circuits, a user identity associated with a user of a service from the mobile device;
obtaining, by the logic circuits, a user profile associated with the user identity;
identifying, by the logic circuits, a trigger event indicating an intention of the user to initiate a service request for a service from the mobile device;
determining, by the logic circuits, based on the user profile and the trigger event, a promotion associated with the user identity; and
generating, by the logic circuits, a message relating to the promotion to be sent to the mobile device.

16. The method of claim 15, wherein the user profile includes at least one of a demographic feature associated with the user, request statistics associated with a plurality of historical service requests by the user, or expenditure statistics associated with expenditure of the plurality of historical service requests.

17. The method of claim 16, wherein the method further includes:
obtaining, by the logic circuits, electronic signals from the bus, the electronic signals including a plurality of historical service requests associated with the user;
identifying, by the logic circuits, a plurality of points of interest associated with the plurality of historical service requests, and
determining, by the logic circuits, the demographic feature based on the identified plurality of points of interest.

18. The method of claim 16, wherein the demographic feature comprises at least one of:
one or more genders;
one or more professions; or
one or more age groups.

19. (canceled)

20. The method of claim 18, wherein the method further includes:
identifying, by the logic circuits, a residential city and a non-residential city;
determining, by the logic circuits, a first type of points of interest and a second type of points of interest;
determining, by the logic circuits, a number of the first type of points of interest associated with the residential city and a number of the second type of points of interest associated with the non-residential city; and
determining, by the logic circuits, the one or more professions based on the number of the first type of points of interest associated with the residential city and the number of the second type of points of interest associated with the non-residential city.

21. The method of claim 20, wherein the method further comprises:
identifying, by the logic circuits, an attribute city and a non-attribute city associated with the user;
determining, by the logic circuits, a number of points of interest associated with the attribute city and a number of points of interest associated with the non-attribute city;
comparing, by the logic circuits, the number of points of interest associated with the attribute city and the number of points of interest associated with the non-attribute city; and
selecting, by the logic circuits, from the attribute city and the non-attribute city, a city as the residential city associated with the user based on a result of the comparison.

22. The method of claim 21, wherein the identified non-attribute city is selected from a plurality of non-attribute cities and the method further comprises:
identifying, by the logic circuits, a plurality of non-attribute cities;
determining, by the logic circuits, a number of residential communities and a number of hotels associated with each of the plurality of non-attribute cities; and
selecting, by the logic circuits, among the plurality of non-attribute cities, the identified non-attribute city based on the number of residential communities and the number of hotels associated with each of the plurality of non-attribute cities.

23. The method of claim 18, wherein the expenditure statistics comprises at least one of:
an amount of the expenditure of the plurality of historical service requests;
an average amount of the expenditure of the plurality of historical service requests; or
a total amount of a plurality of used promotions in the plurality of historical service requests.

24. (canceled)

25. (canceled)

26. (canceled)

27. (canceled)

28. (canceled)

29. The system of claim 2, wherein the request statistics comprises at least one of
a number of the plurality of historical service requests;
a number of historical requests using promotions of the plurality of historical service requests;
an average mileage of the plurality of historical service requests;
starting locations and destinations of the plurality of historical service requests; or
at least one city factor.

30. The method of claim 16, wherein the request statistics comprises at least one of:
a number of the plurality of historical service requests;
a number of historical requests using promotions of the plurality of historical service requests;
an average mileage of the plurality of historical service requests;
starting locations and destinations of the plurality of historical service requests; or
at least one city factor.
